(19) United States
(12) Patent Application Publication
(10) Pub. No.: US 2024/0195258 A1
(43) Pub. Date: Jun. 13, 2024

(54) STATOR OF AN ELECTRIC MOTOR AND ELECTRIC MOTOR HAVING THE STATOR

(71) Applicant: Brose Fahrzeugteile SE & Co. Kommanditgesellschaft, Würzburg, Würzburg (DE)

(72) Inventors: Marco Grimm, Unterschleissheim (DE); Stefan Wüst, Lohr am Main (DE)

(21) Appl. No.: 18/531,884

(22) Filed: Dec. 7, 2023

(30) Foreign Application Priority Data
Dec. 7, 2022 (DE) 10 2022 213 212.2

(51) Int. Cl. H02K 3/52

(52) U.S. Cl. CPC H02K 3/522

(57) ABSTRACT

A stator of an electric motor includes a stator main body with radially oriented stator teeth, which carry coils of a multi-phase coil winding. A stator cap has at least one receiving contour into which at least one winding section of the stator winding is inserted. At least one contact connection has a deformable contact hook which receives the winding section in the course of a joining process and contacts the winding section captively following a deformation process. An electric motor having the stator is also provided.

### CROSS-REFERENCE TO RELATED APPLICATION

This application claims the priority, under 35 U.S.C. § 119, of German Patent Application DE 10 2022 213 212.2, filed Dec. 7, 2022; the prior application is herewith incorporated by reference in its entirety.

### FIELD AND BACKGROUND OF THE INVENTION

The invention relates to a stator of an electric motor, having a number of stator teeth, which carry coils of a multi-phase coil winding, and a stator cap. The invention further relates to an electric motor having such a stator.

An electric motor of that type is configured as a so-called brushless electric motor (brushless DC motor, BLDC motor), in which wear-prone brush elements of a mechanical commutator are replaced by electronic commutation of the motor current. A brushless electric motor, as an electric (three-phase) machine, has a stator with a stator main body or stator lamination pack having a number of stator teeth, for example directed radially inward, which carry an electric three-phase or stator winding in the form of individual stator coils, which are wound from an insulated wire. The coils are assigned to individual strands or phases of the machine and wired with one another in a predetermined way, for example a delta circuit.

In a three-phase electric motor, the stator has a stator winding with three phases and thus, for example, three phase conductors or phase windings, which are each acted on or energized with electric current with a phase offset in order to generate a rotating magnetic field, in which a rotor usually provided with permanent magnets rotates.

The phase ends of the phase windings are attached to a contact device to activate the electric motor, which contact device, for example according to International Publication WO 2016/008827, has a plug connection in the form of a knife-like insulation displacement contact. The coils of the stator winding are interconnected with one another in a specific way by using a wiring element placed on the front end of the stator, a star circuit or a delta circuit of the phase windings being usual as a winding or connection scheme.

In order to interconnect the coils, at least one wire section of the winding wire that is to be contacted or a winding section of the stator winding that is to be contacted is inserted into a first slot of a cubic slip pocket of the wiring element and contacted electrically and fixed mechanically within the slip pocket by using an insulation displacement contact of the contact element that can be inserted into the slip pocket. The contact element is inserted in the direction of the stator by using an insertion press tool, which, on the side of the contact element that faces axially away from the insulation displacement contact, is placed on a horizontally extending upper edge.

The insulation displacement contact of the contact element has a blade which, when inserted into the slip pocket of the wiring element, cuts through the insulation of the wire section of the coil winding that is located in the first slot and produces the electrical contact with the insulation displacement contact. At the side axially opposite the insulation displacement contact, the contact element has a contact slot extending axially, into which a bus bar of a contact device is or can be inserted in an electrically clamping-contacting manner. The contact device can be configured as a circuit board carrying the motor electronics or as a plug connection.

In particular in needle-wound or robot-wound stators, the interconnection of the stator winding with the phase contacts in the insulation displacement technique can lead to undesired contact malfunctions as a result of tolerance deviations, for example. If, however, a heat-seal process between the stator winding and the phase or motor contacts is preferred and use is made of the usual hook geometries to contact the typical round wires of the stator winding and the coil connections thereof, then an undesirably more complicated or more costly automation or robot process is required when inserting wire loops, particularly since the positioned wire loops must be under tension until the sealing process, in order to avoid sliding out of the open hooks. In particular, the hook would already have to be integrated in an existing stator cover cap. This is again undesired, in particular with regard to a desired generic interface.

### SUMMARY OF THE INVENTION

It is accordingly an object of the invention to provide a particularly suitable stator of an electric motor and a particularly suitable electric motor having such a stator, which overcome the hereinafore-mentioned disadvantages of the heretofore-known stators and motors of this general type. In particular, fail-safe, tolerance-independent and/or easily automatable contacting of a stator winding with phase contacts, in particular motor electronics, is to be implemented.

With the foregoing and other objects in view there is provided, in accordance with the invention, a stator of an electric motor having a hollow-cylindrical stator main body with a number of stator teeth oriented radially—with reference to the cylinder axis—which carry coils of a multi-phase stator winding. Furthermore, the stator has an in particular annular stator cap disposed on the front end of the stator main body and having at least one receiving contour into which at least one winding section of the stator winding, also designated a (round) wire or coil end below, is inserted. Furthermore, the stator has at least one contact connection with a deformable contact hook, which receives the at least one winding section (round wire, coil end) in the course of a joining process and contacts the same captively following a deformation process. In a stator with a three-phase stator winding, three receiving contours and three contact connections are suitably provided with deformable contact hooks. The receiving contour and the contact hook are preferably provided and configured to receive at least two winding sections (round wires, coil ends).

With the objects of the invention in view, there is also provided an electric motor having the stator according to the invention.

Advantageous refinements and developments are the subject matter of the subordinate claims. The advantages and refinements listed with regard to the stator are also correspondingly transferable to the electric motor and vice versa.

In an expedient refinement, the stator cap has a, preferably annular, cap section and a collar section on the rim. The stator cap has a number of apertures for the respective winding section of the stator winding, wherein the apertures or openings are provided in the collar section and/or in the cap section. Preferably, the collar section at the rim engages over or around the stator main body on a (stator) front end.

The invention is based on the concept of contacting one or more round wires or winding sections of the stator winding of an electric motor, and of providing a motor phase contact with integrated (contact) hook, the hook geometry of which is configured or should be in such a way that when this is joined to the wound stator this automatically catches a pre-positioned winding section, for example corresponding round wires or coil ends. Furthermore, during the (heat) sealing, the winding sections (round wires) caught in the hook should be centered automatically in the hook by compressing the hook geometry, so that during and after the seal process or crimping, the winding section or each winding section or the wires can no longer slide out of the hook.

In an advantageous refinement, the receiving contour is formed by a number of receiving channels or insertion grooves, into which the at least one winding section of the coil winding is inserted. The receiving contour is suitably configured in such a way that at least two winding sections, round wires or coil ends, can be received, in particularly axially above one another.

Particularly preferably, the receiving contour is formed in a number of axial lugs spaced apart from one another. Expediently, the axial lugs are molded onto the stator cap, in particular on its, preferably annular, cap section. In particular, the axial lugs have axial webs spaced apart from one another at the free ends, forming the, preferably slot-like or groove-like, receiving contour.

The receiving channels or insertion grooves are preferably axially accessible. In other words, the receiving channels or insertion grooves and thus the receiving contour for the winding section or each winding section extend in the axial direction. In addition, the receiving channels or insertion grooves are suitable and provided to receive, for example, two winding sections or coil ends. Following the winding operation, in which the coils or the stator winding are wound onto or applied to the stator teeth, these initially project beyond the stator main body at one front end and are preferably oriented axially. The stator cap is then placed onto the stator main body at this front end, wherein the axially oriented coil ends or connections reach through corresponding openings in the stator cap. The coil ends are then bent over preferably in the circumferential direction of the stator (azimuthally) and inserted in this case into the receiving contours, preferably in the form of the receiving channels or insertion grooves. This process is likewise preferably carried out automatically.

In a suitable way, the contact hook of the contact connection engages between the axial lugs in the axial direction in the course of the joining process and receives in this case the or each winding section of the stator winding inserted into the receiving contour.

Particularly expediently, the contact connection is a U-shaped stamped and bent part, of which one U leg is expediently bent in an L shape, forming the contact hook. Thus, a heat-sealing tool, for example a welding gun, can engage (over) both hook legs of the contact hook with the winding sections received therein and press them against each other. Preferably, the contact hook of the contact connection has an in particular eye-like and/or conical contact region and/or clamping gap between (the) two contact legs for the or each winding section of the stator winding.

The contact hook of the contact connection suitably has a receiving or entry region that is acute-angled in cross section for the respective winding section of the stator winding, the angle of the entry region being (35±15)°, preferably between 20° and 45°.

The electric motor according to the invention is in particular configured as a brushless electric motor and is suitable and configured as a drive for an adjustment element or as a brake motor for an anti-lock brake system of a motor vehicle. The electric motor has, for example, a pot-shaped motor housing (pole pot) which, at the end, can be closed with a bearing shield, wherein an above-described stator is inserted into the motor housing. Through the use of the stator according to the invention, a particularly suitable electric motor is implemented which, in particular with regard to different applications or customer requirements, can be adapted particularly easily and flexibly to a respective customer interface.

The electric motor is configured, for example, as an internal rotor motor, in which a rotor co-rotationally fixed to a motor shaft rotates in the rotating field of the stationary stator (fixed to the housing) enclosing the latter. The motor shaft is rotatably mounted in this case, for example, by using an anti-friction bearing of the bearing shield. The electric motor or its stator is assigned (motor) electronics for the, for example three-phase, energization of the stator winding, wherein the electronics can be disposed in the motor housing. The contact connections are contacted by and electrically and mechanically connected to the electronics, wherein the contact connections are in turn connected to the winding sections of the stator winding in the manner described.

Other features which are considered as characteristic for the invention are set forth in the appended claims.

Although the invention is illustrated and described herein as embodied in a stator of an electric motor and an electric motor having the stator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a stator of an electric motor having a hollow-cylindrical stator main body with radially inwardly oriented stator teeth and coils of a stator winding disposed thereon;

FIG. 2 is a view according to FIG. 1 showing the stator with the stator cap attached at the end and with winding sections of the stator winding inserted into a receiving contour and gripped by a hook-shaped contact connection;

FIG. 3 is an enlarged, fragmentary, perspective view of the contact hook of the contact connection in a joining position axially above the winding sections to be gripped;

FIG. 4 is an enlarged, fragmentary, perspective view of the winding sections inserted into the cap-side receiving contour and gripped by the contact hook during a joining process and (chronologically) before a deformation process;

FIG. 5 is a perspective view of the contact connection with a contact hook that is angled over or bent over by a contact leg shown in section;

FIG. 6 is a side-elevational view of the contact hook of the contact connection with a view into a contact and/or clamping region formed between hook legs and an acute-angled receiving or insertion region for the winding sections; and

FIGS. 7a and 7b are side-elevational views diagrammatically illustrating the contact hook before and after the deformation process, in particular the (heat) sealing process, preferably by using a welding gun.

### DETAILED DESCRIPTION OF THE INVENTION

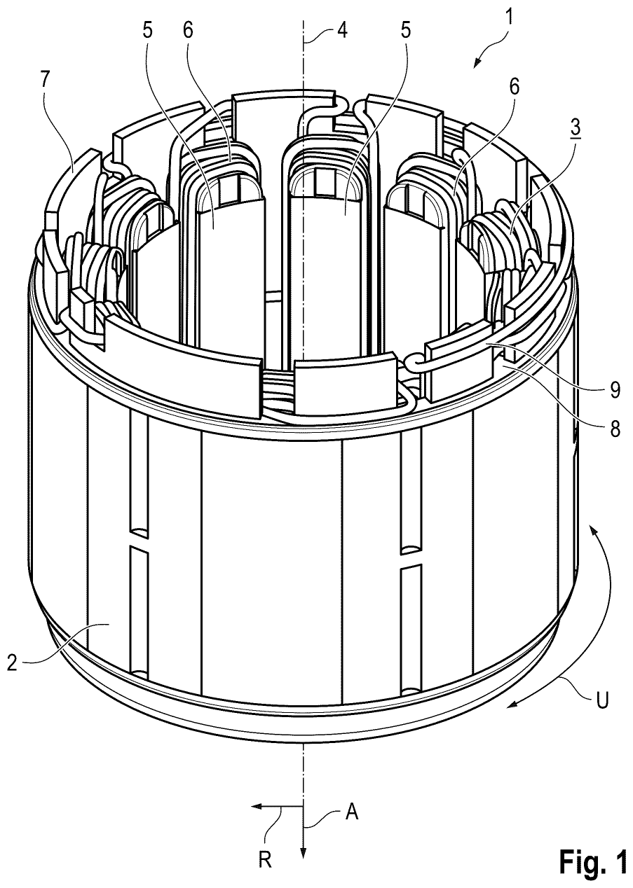

Referring now in detail to the figures of the drawings, in which mutually corresponding parts and sizes are provided with the same designations, and first, particularly, to FIG. 1 thereof, there is seen a stator 1 of an electric motor having a hollow-cylindrical stator main body 2 and having a stator winding 3. A cylinder axis 4 and an axial direction A based thereon and a radial direction R, based thereon and likewise on the cylinder axis 4, are illustrated in FIG. 1. The stator main body 2 is formed, for example, as a lamination pack made of stacked stator laminations. The stator main body 2 has radially inwardly directed stator teeth 5 with coils 6 disposed thereon, preferably in an automated winding method or winding process, which form the stator winding 3.

Axially extending slots or grooves 8 are provided on a front end 7 (which is an upper end in FIG. 1) of the stator main body 2. Winding sections 9 of the coils 6 or some of the coils 6 are led and laid over the slots or grooves 8 in the circumferential direction U of the stator 1. In this way, for example in a three-phase stator winding 3, a plurality of coils 6 of one phase are respectively disposed on different stator teeth 5 and connected to one another.

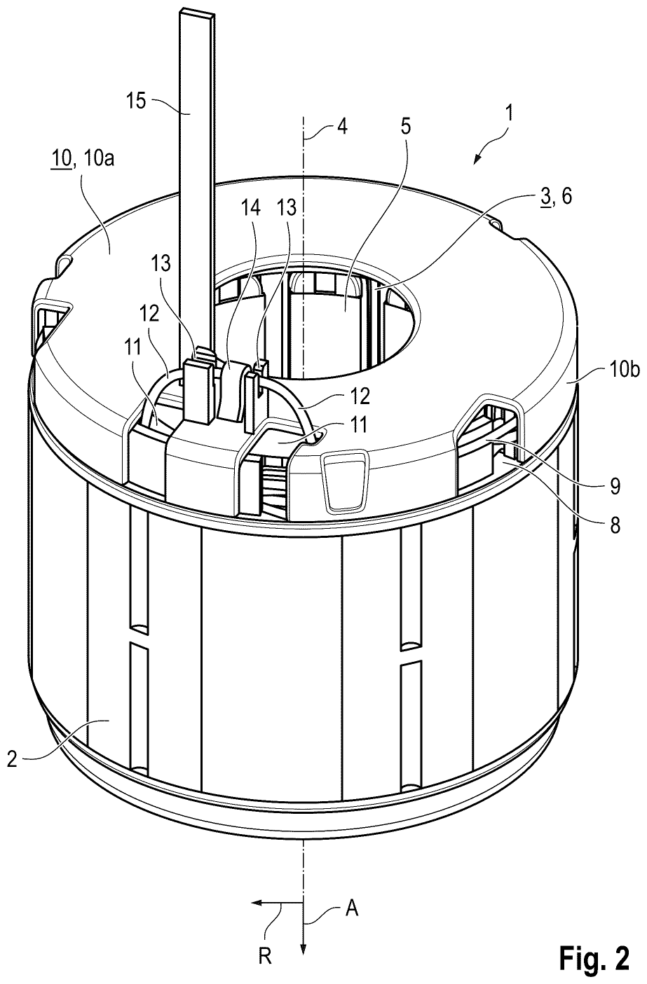

FIG. 2 shows the stator 1 with the stator main body 2 and with a stator cap 10 placed on its front end 7. The stator cap 10 has an annular cap section 10a and a circumferential collar or rim section 10b, which is molded thereon at the rim and engages over the stator main body 2 at the front end. The stator cap 10 has apertures or openings 11, over which winding sections or coil ends 12 are initially led out axially. These winding sections (coil ends) 12 are inserted into a receiving contour 13 provided on the upper side of the cap section 10a of the stator cap 10, preferably once more automatically.

In the region of the receiving contour 13, the winding sections 12 are gripped by a contact hook 14 of a contact connection 15, which is oriented axially in the exemplary embodiment. The contact connection 15 preferably forms a phase connection of the stator winding 3. In the same way, for example, two further phase connections are produced by using corresponding contact connections 15, by these in turn gripping and contacting, by using their contact hooks 14, at least one further winding section 12 or corresponding coil ends. As a result, the coils 6 of the stator winding 3 are interconnected, for example, in a delta circuit.

In a manner which is not specifically illustrated, the stator 1 is a constituent part of an electric motor, of which the rotor co-rotationally disposed on a motor shaft (rotor shaft) and fitted with permanent magnets is enclosed by the stator 1 and, when the stator winding 3 is energized, rotates in the rotating field produced in this case. Such an electric motor is a brushless, electronically commutated internal rotor motor. The phase-selective energization of the stator winding 3 is carried out via (motor) electronics, which are connected to or electrically contacted by the or each phase connection in the form of the respective contact connection 15.

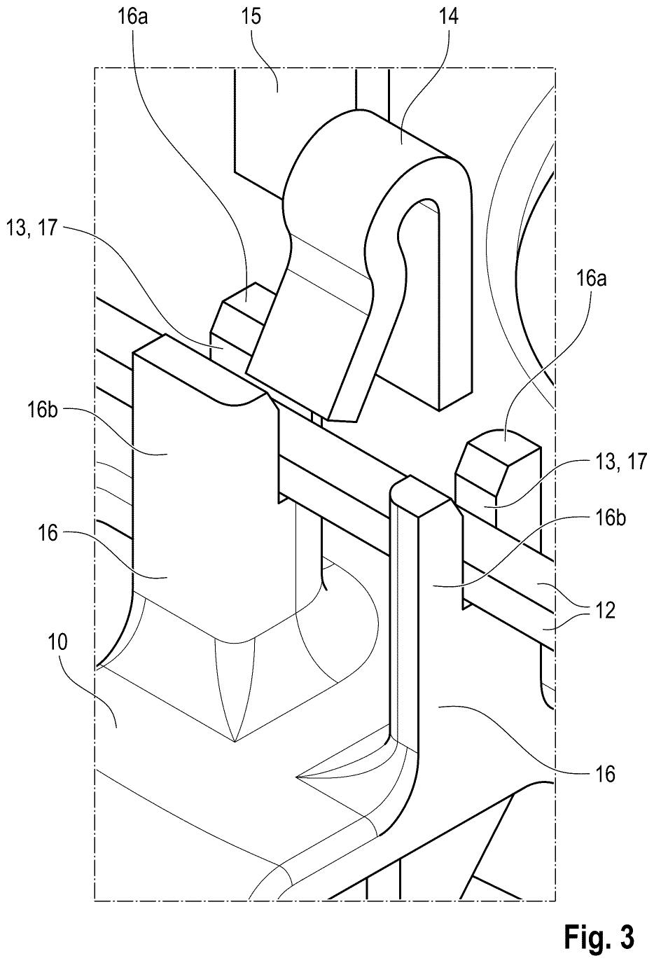

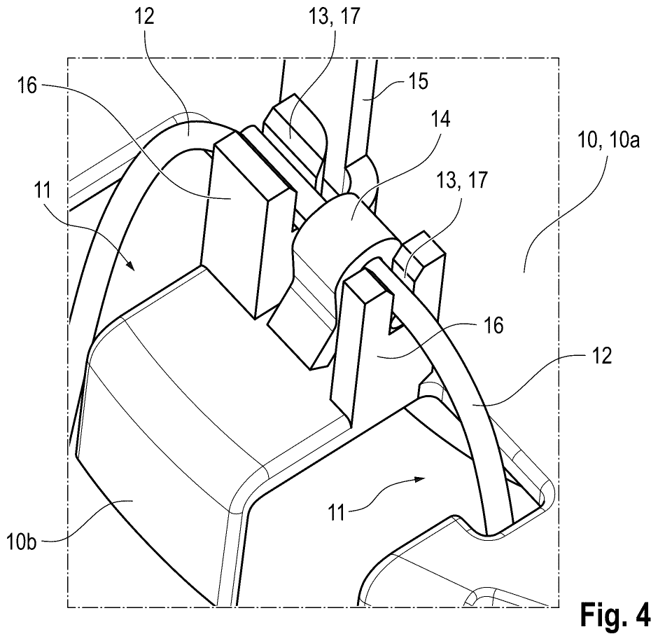

As can be seen comparatively clearly from FIGS. 3 and 4, the respective receiving contour 13 for the coil ends or winding sections 12 is formed in axial lugs 16 spaced apart in the circumferential direction U (azimuthally or tangentially) in the exemplary embodiment. These lugs are molded onto the stator cap 10 and, there, onto the annular cap section 10a—on its upper side. These axial lugs 16 extend in the axial direction A and, on the free ends, between mutually spaced, in particular fork-like, axial webs 16a, 16b, have slots or grooves 17 open at the top or ends, which form the axially accessible receiving contours 13 in the form of corresponding receiving channels. In the latter, the two winding sections or coil ends 12 formed as round wires in the exemplary embodiment are inserted axially beside one another or above one another.

The distance between the axial lugs or webs 16 is matched to the width of the contact hook 14 of the contact connection 15 in such a way that, in the course of a, preferably automated, joining process, the contact hook 14 can engage between the two contact webs 16 and receive the winding sections 12 in this case.

FIG. 3 shows in this case the contact hook 14 already moved into the appropriate joining position between the axial lugs 16, before this contact hook 14 has received the winding sections 12.

FIG. 4 shows a further step in the joining process, in which the contact hook 14 has moved or traveled further in the axial direction A and in the process has engaged over the two winding sections 12, so that these are inserted into the contact hook 14.

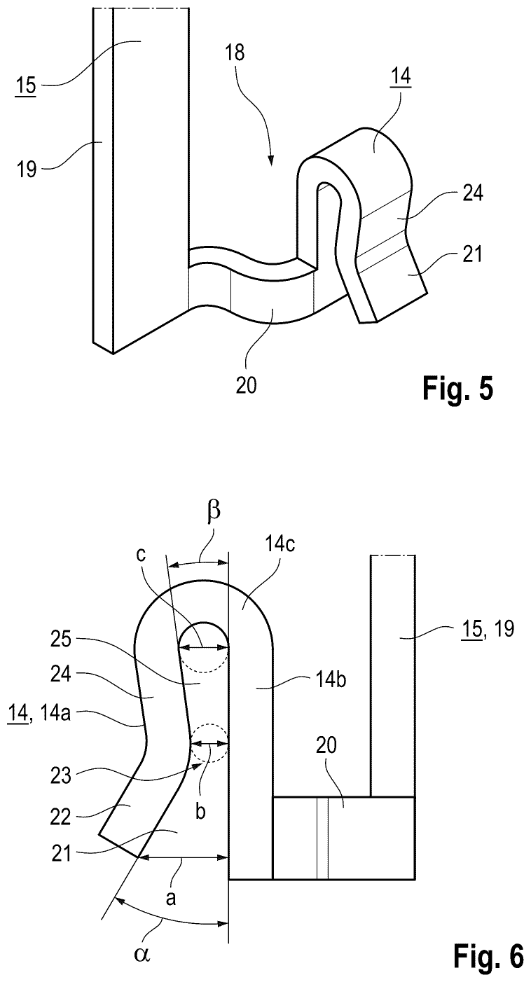

FIG. 5 shows (as a detail) the contact connection 15 and the contact hook 14 in the preferred configuration as a stamped and bent part. As can be seen, this part is U-shaped in the initial state, one of the U legs 18 preferably being bent in an L shape, forming the contact hook 14, and correspondingly bent away from the other U leg 19. In the exemplary embodiment, a connecting leg 20 between the U legs 18, 19 is bent or angled approximately in an S shape in this case. In this way, the contact hook 14—uncovered by the U leg 19 of the contact connection 15—is freely or unimpededly accessible for a welding gun or the like.

FIG. 6 shows—once more as a detail—the contact connection 15 having the contact hook 14 in a side view. It can be seen that the contact hook 14 itself is again U-shaped with two hook legs 14a and 14b. The hook leg 14b is connected to the contact connection 15 and to the U leg 19 via the connecting web 20. The hook leg (free leg) 14a of the contact hook 14, which is free at one leg end and can thus be deformed with respect to the fixed hook leg 14b, has a flared leg section 22 on the free end side. As a result, an acute-angled receiving or entry region 21 for the respective winding section 12 is formed. As a result, fail-safe gripping of the winding sections 12, in particular including to compensate for tolerances, is made possible. The illustrated angle α is preferably between 20° and 45°

In this entry region 21, the distance or the clear width a between the two hook legs 14a and 14b is preferably greater than, in particular at least twice as large as, the wire or winding diameter of the respective winding section or coil end 12.

In a transition region 23 between the flared leg section 22 and a leg section 24 of the corresponding hook leg 14a that follows the same, the distance or the clear width b between the hook legs 14a and 14b is equal to or only slightly larger than the wire or winding diameter of the winding section 12. This transition region 23 of the contact hook 14 forms, so to speak, a constriction for the respective winding section 12 of the stator winding 3 or for the coil end of a corresponding coil 6.

Opposite the insertion region 21, the transition region 23 or the constriction formed thereby and having the clear width b is adjoined by a receiving or contact region 25. This region 25 is widened conically toward a connecting leg 14c between the two hook legs 14a and 14b of the contact hook 14. The maximum clear width c between the two hook legs 14a and 14b of the contact hook 13 is preferably larger in this region 25, in particular larger by at least 10% or approximately the factor 1.1, than the wire or winding diameter of the winding section or coil end 12. The illustrated angle β of this once more preferably acute-angled receiving region 25 between the two hook legs 14a and 14b is in particular less than 45° and greater than 0°.

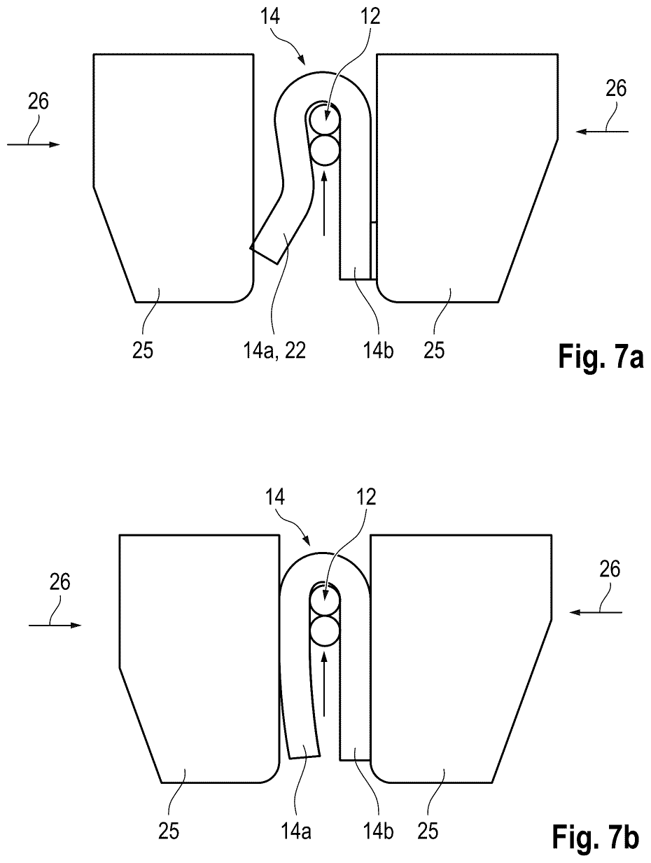

FIGS. 7a and 7b illustrate a deformation process of the contact hook 14 following the joining process, in which the winding sections or coil ends 12 have been received by the contact hook 14 and inserted into the latter.

FIG. 7a in this case illustrates the precise orientation of the winding sections, coil ends or round wires 12 because of the specific hook geometry of the contact hook 14. The directional arrows 26 in this case illustrate the direction of movement of a welding gun 27, for example, used for the deformation process.

FIG. 7b shows the contact hook 14 deformed in the course of the deformation process by using the welding gun 27—and preferably additional input of heat. As can be seen, the hook leg 14a, also designated the free leg, is deformed in the course of the deformation process in such a way that the hook region or leg region 22 flared out before the deformation is deformed or reshaped in the direction of the other hook leg 14b. The originally acute-angled entry region 21 of the contact hook 14 is or has been reduced in this case to a clear width which is smaller than the wire or winding diameter of the winding section or coil end 12. In this way, the coil ends or winding sections 12 are contacted reliably and captively received in the deformed contact hook 14.

In summary, the invention relates to a stator 1 having a stator main body 2 with radially oriented stator teeth 5, which carry coils 6 of a multi-phase coil winding 3, and having a stator cap 10 with at least one receiving contour 13 into which at least one winding section 12 is inserted, and having at least one contact connection 15 with a deformable contact hook 14, which receives the winding section 12 in the course of a joining process and captively contacts the same following a deformation process.

The invention claimed is not restricted to the above-described exemplary embodiment. Instead, other variants of the invention can also be derived therefrom by those skilled in the art within the context of the disclosed claims without departing from the subject matter of the claimed invention. In particular, furthermore, all of the individual features described in conjunction with the various exemplary embodiments can also be combined in another way within the scope of the disclosed invention without departing from the subject matter of the claimed invention.

The following is a summary list of reference numerals and the corresponding structure used in the above description of the invention.

### LIST OF DESIGNATIONS

1 Stator
2 Stator main body
3 Stator winding
4 Cylinder axis
5 Stator tooth
6 Coil
7 Front end
8 Slot/groove
9 Winding section
10 Stator cap
10a Cap section
10b Collar-/rim section
11 Aperture/opening
12 Winding section/coil end
13 Receiving contour
14 Contact hook
14a Deformable hook leg/free leg
14b Fixed hook leg
14c Connecting leg
15 Contact connection
16 Axial lug
16a Axial web
16b Axial web
17 Slot/groove
18 U leg
19 U leg
20 Connecting leg
21 Receiving/entry region
22 Hook region/leg section
23 Transition region/constriction
24 Leg section
25 Clamping/contact region
26 Directional arrow
27 Welding gun
A Axial direction
R Radial direction
U Circumferential direction
a,b Distance/clear width
c Clear width
α,β Angle

1. A stator of an electric motor, the stator comprising:
a hollow-cylindrical stator main body having a front end, a cylinder axis and a plurality of stator teeth oriented radially relative to said cylinder axis, said stator teeth configured to carry coils of a multi-phase coil winding;
a stator cap disposed at said front end of said stator main body, said stator cap having at least one receiving contour for receiving at least one inserted winding section of the stator winding; and
at least one contact connection having a deformable contact hook, said deformable contact hook configured to receive the at least one winding section in a course of a joining process and to contact the at least one winding section captively following a deformation process.

2. The stator according to claim 1, wherein said stator cap has an annular shape.

3. The stator according to claim 1, wherein said at least one receiving contour is formed by a plurality of receiving channels configured to receive said at least one inserted winding section of the stator winding.

4. The stator according to claim 3, wherein said plurality of receiving channels are axially accessible.

5. The stator according to claim 1, wherein said at least one receiving contour is formed in a plurality of axial lugs being spaced apart from one another.

6. The stator according to claim 5, wherein said axial lugs are molded onto said stator cap, and said axial lugs have free ends with axial webs being spaced apart from one another, forming said at least one receiving contour.

7. The stator according to claim 6, wherein said receiving contour is channel-shaped, slot-shaped or groove-shaped.

8. The stator according to claim 5, wherein said contact hook of said at least one contact connection is configured to engage between said axial lugs in an axial direction in the course of the joining process and to receive the at least one winding section of the stator winding inserted into said at least one receiving contour.

9. The stator according to claim 1, wherein said at least one contact connection is a U-shaped punched and bent part having one U leg being bent and forming said contact hook.

10. The stator according to claim 9, wherein said one U leg is bent in an L shape.

11. The stator according to claim 1, wherein said contact hook of said at least one contact connection has two hook legs and at least one of a contact or clamping region between said two hook legs for receiving the at least one winding section of the stator winding.

12. The stator according to claim 11, wherein said contact or clamping region is eye-shaped or conical.

13. The stator according to claim 1, wherein said contact hook of said at least one contact connection has an acute-angled receiving or entry region enclosing an angle of 35±15°.

14. The stator according to claim 13, wherein said angle is between 20° and 45°.

15. The stator according to claim 6, wherein said stator cap has an annular cap section, a rim, a collar section on said rim and a plurality of apertures each configured for receiving a respective winding section of the stator winding, said at least one receiving contour or said axial lugs being molded onto said stator cap.

16. The stator according to claim 15, wherein said cap section is annular, said at least one receiving contour or said axial lugs being molded onto said cap section.

17. An electric motor, comprising the stator according to claim 1.
